(19) United States
(12) Patent Application Publication
(10) Pub. No.: US 2012/0290654 A1
(43) Pub. Date: Nov. 15, 2012

(54) Rewarding Users for Sharing Digital Content

(76) Inventors: Dennis Detwiller, San Francisco, CA (US); Robert Sparks, Vancouver (CA)

(21) Appl. No.: 13/306,917

(22) Filed: Nov. 29, 2011

Related U.S. Application Data
(63) Continuation of application No. 13/106,716, filed on May 12, 2011.

(51) Int. Cl. G06F 15/16

(52) U.S. Cl. 709/204

(57) ABSTRACT

A computer-implemented method, apparatus, and computer-readable medium of rewarding a user for sharing digital content are described. The method facilitates an effective way of sharing commercial digital content via a network, such as the Internet, while the users who share the content are provided with a real or virtual reward. The method may comprise receiving, from a user, a request to share digital content, retrieving the digital content to be shared, with the digital content being associated with a user, transmitting the digital content to one or more destinations for sharing, and providing a reward to the user.

### BACKGROUND

A. Technical Field

This disclosure relates generally to incentive rewarding and, more specifically, to rewarding users responsive to sharing digital content online.

B. Description of Prior Art

Social networks, blogs, microblogging services, news feeds, websites, e-mail subscriptions, and other social utilities are widely used by companies and individuals to distribute information (e.g., frequently updated content) via the Internet. Companies tend to motivate users to distribute such marketing content further via networks of user contacts. Some websites entries, such as social network messages, blog entries, e-mails and other social messages may include a share functionality, for example via a share button, which can be selected by a user to distribute selected content via one or more online resources. For example, a user may select the “Share” button associated with a news feed entry he likes, which transfers the user to a utility allowing the user to share the news feed entry with members of a user's social network. This sharing may result, for example, in a link to the news feed entry being posted on a social networking website so that other members of the user's social network can view and access the shared content by clicking on the link. Similarly, the user can be provided with an option to distribute the news feed content by e-mail to one or more user contacts. In addition, the “Share” button may allow users to reenter third party content via various resources, such as microblogging websites.

The sharing features of various social media websites is very helpful to companies in spreading key messages, driving traffic to associated websites, and increasing the number of product and service purchases in a quick and cost efficient manner. Companies may run contests to encourage users to share content and build web-based games to promote a game company, a product or a service. However, there is no practical way to track user activity associated with sharing promotional information within social networks, blogs, and so forth. In addition, the users may be reluctant to share commercial content in absence of incentive.

### SUMMARY

The present technology tracks and rewards user sharing and broadcast of information via of social media. The information may include content associated with products, services and other information over a network digital. This technique encourages users to spread content, such as for example commerce-related content, via social media to connected members for a reward.

In one embodiment, a computer-implemented method for user rewarding is provided. The method may include receiving a sharing user request for sharing digital content associated with a user, retrieving the digital content, transmitting the digital content to one or more destinations for sharing, and providing a reward to the user.

In one example, the one or more destinations may include a social networking website, a blog, a microblog, a website, an e-mail server, a web server, and a database. In another example, the method may further include retrieving user credentials, with the user credentials being used for accessing one or more destinations. The method may further include receiving a confirmation message upon successful delivery of the content to a destination. The confirmation message may be a basis for providing the reward to the user. The amount of reward may be based on one or more of the following: a shared content type, a number of destinations, traffic generated due to sharing of the digital content, a number of visitors to a website associated with the shared content, and a number of sales associated with the shared content.

In yet another example, the method may further include receiving sharing parameters from the user. The transmission of the content to one or more destinations may be based at least in part on the sharing parameters. The sharing parameters may indicate one or more of the following: description of the digital content the user wishes to share, how the content is to be formatted in accordance with the user wishes, and at which destinations the user wishes the content to be shared. The sharing request may be received responsive to the user selection of a website control or a software control, wherein the website control includes an object contained within the website that executes a predetermined set of instructions when selected by the user, and wherein the software control includes an object in the software that executes a predetermined set of instructions when selected by the user.

According to yet another embodiment, an apparatus for rewarding users is provided. The apparatus may include at least one processor configured to receive a sharing user request for sharing digital content, retrieve the content to be shared, with the content being associated with a user, transmit the content to one or more destinations for sharing, and provide a reward to the user.

In one example, the one or more destinations may include a social networking website, a blog, a microblog, a website, an e-mail server, a web server, and a database. The at least one processor may further be configured to retrieve user credentials, with the user credentials being used for accessing one or more destinations. The at least one processor may further be configured to receive a confirmation message upon successful delivery of the content to the destination. A reward may be provided to the user based on the confirmation message. The amount of the reward may be associated with one or more of the following: a shared content type, a number of destinations, traffic generated due to sharing of the digital content, a number of visitors to a website associated with the shared content, and a number of sales associated with the shared content.

In yet another example, the at least one processor may further be configured to receive sharing parameters from the user. The transmission of the content to the one or more destinations may be based at least in part on the sharing parameters. The sharing parameters may indicate one or more of the following: which content the user wishes to share, how the content is to be formatted in accordance with the user wishes, and at which destinations the user wishes the content to be shared.

According to yet another embodiment, a computer-readable medium having instructions stored thereon is provided. When instructions are executed by one or more computers, they may cause the one or more computers to receive a sharing user request for sharing digital content, retrieve the content to be shared, with the content being associated with a user, transmit the content to one or more destinations for sharing, and provide a reward to the user.

### BRIEF DESCRIPTION OF THE DRAWINGS

FIG. 1 is a block diagram illustrating an exemplary system environment suitable for sharing digital content and rewarding users responsive thereto, according to an exemplary embodiment.

FIG. 2 is a diagram of an exemplary reward system according to an exemplary embodiment.

FIG. 3 illustrates an exemplary method for sharing digital content and rewarding users for sharing content, according to an exemplary embodiment.

FIG. 4 is a web page of an external social media website displayed in a web browser of a client device, according to an exemplary embodiment.

FIG. 5 is a diagrammatic representation of an example machine in the form of a computer system within which a set of instructions, for the machine to perform any one or more of the methodologies discussed herein, is executed.

### DETAILED DESCRIPTION

The present technology tracks and rewards user sharing and broadcast of information via of social media. An immediate reward, whether monetary, virtual or other, may be provided for sharing information such as a message within a user's network within a networking service social as a social network. The information may include content associated with products, services and other information over a network digital. This technique encourages users to spread content, such as for example commerce-related content, via social media to connected members for a reward. The content may be shared via one or more destinations associated with a network service. Exemplary destinations may include a social networking website, a blog, a microblog, a website, an e-mail server, a web server, and a database.

The present technology may allow a user to obtain rewards by sharing content via a mobile device. A user may be executing a client or network-based application on a mobile device, and share information about the application through a social network service. The reward may be provided through the application once the sharing of the information is confirmed. As such, the mobile device may be used to select information to share as well as access a reward for sharing the information.

To obtain a reward, content may be shared as an achievement in a game, the act of participating in a game or program, or other solo activity. A user may also share content as part of a group of users in the program or game sharing a particular portion of content, sharing at a particular time, or otherwise sharing content with a common aspect. In some embodiments, a game may provide players with notifications of available rewards if they share a particular content at a particular time, a group of players share content at a particular time, or other conditions are met. Other actions that may trigger granting a reward may include re-broadcasting content shared by another user of a social network (e.g., re-tweeting), providing a pyramid scheme game that rewards users for sharing, providing group sharing based on desirable metrics, geo-based rewards, and other actions.

The reward provided to the user may be based at least on part on how the content or information is shared. For example, a user reward may have a quantity or value that is proportional to the number of contacts the content is shared with, such as a first reward for sharing with one user and a second reward if shared with five users. A reward may also be based on an action of a contact that receives the shared content, such as an action of signing up for the service from which the reward was provided. The rewards may be available to the user and others through a normal application experience or only as a result of sharing information (the latter serving as an extra incentive to encourage users to share the information).

The embodiments disclosed herein relate to sharing digital content via social media and rewarding responsive thereto. The term “social media” may refer to various network-based tools and services that enable people to communicate via networks such as the Internet and to share information and resources. Social media can include text, audio, video, images, podcasts, and other multimedia communications. Typical social media tools and services are social networking systems (websites), blogs, microblogs, podcasts, chats, web feeds (or news feeds, RSS feeds), information aggregators, content sharing tools, and so forth.

Social media can be implemented in various types of systems. For example, the implementation of a social network or a blog can provide mechanisms for members to communicate with each other, form connections with each other, store information, and share information of interest, among other things. In use, members may join social media networks and then add connections to a number of other members to whom they desire to be connected. Traditionally, such connected members are also known as “friends.” Social networking websites and blogging websites maintain member profiles for each member. Any action that a particular member takes with respect to another member or any action on any objects maintained on the social networking and blogging websites may be logged in association with the member's profile. The logged actions may then be tracked by members or non-members by reviewing the member's profile or by viewing a status feed associated with the member. The tracked actions may include, for example, adding new content (e.g., a post, a blog entry, a comment, and a message), adding a connection to another member, sending/reading messages, and so forth. Any action taken by members may be recorded in a log file or alike.

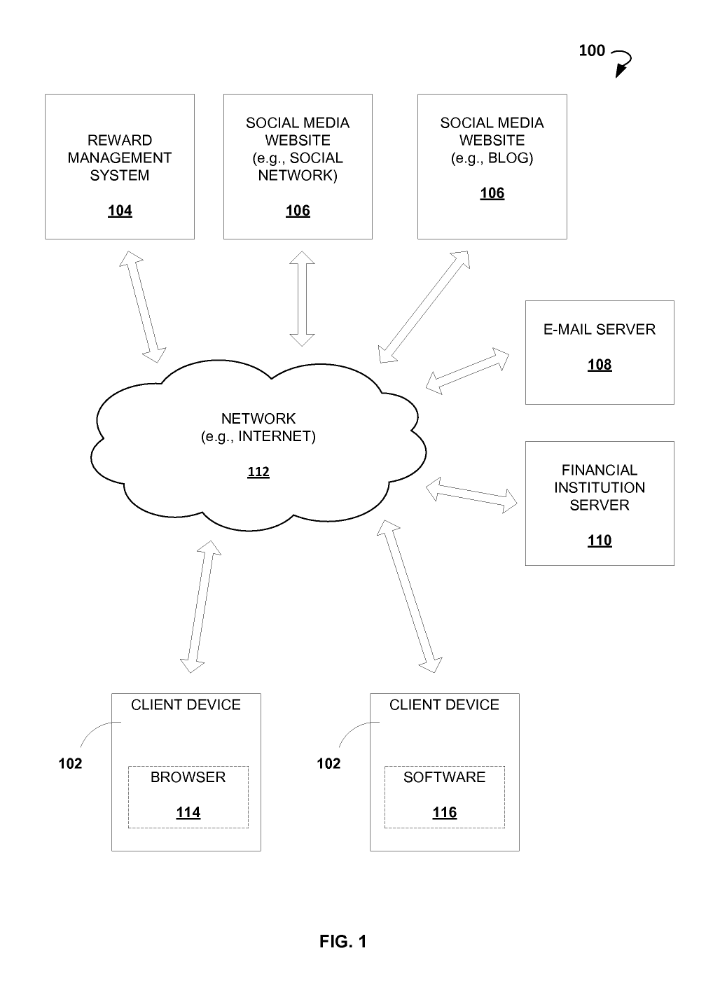

Referring now to the drawings, FIG. 1 is an exemplary block diagram illustrating a system environment suitable for sharing digital content and rewarding users responsive thereto, according to an exemplary embodiment. The system environment 100 may include one or more client devices 102, a reward management system 104, one or more social media websites 106, one or more e-mail servers 108, one or more financial institution servers 110, and a network 112. The network 112 may include a public network, private network, intranet, the Internet, a LAN, WAN, and a combination of these, and may communicatively couple all the above-mentioned modules.

As used herein, a client device may be implemented as a cellular phone, smart phone, a tablet computer, a portable computing device, a personal digital assistant (PDA), a handheld device having wireless connection capability, or any other electronic device with the ability to receive and transmit data via a cord or cordless network (e.g. with the ability to browse the Internet), such as a a computer or a laptop.

In some embodiments, the client devices 102 may include a browser application 114 providing the ability to browse and interact with web services implemented by web servers, application servers, and other computing devices. Each web service may provide one or more content pages (e.g., websites) via the Internet. A content page may be retrieved from the network service and provided through a network browser application. In some other embodiments, the client devices 102 may include software 116 to communicate with the reward management system 104 and other devices of system 100. The software 116 may be part of another computer program, such as a computer game.

The social media website 106 may be provided by web services implemented by web servers, application servers, and other computing device. Website features may include a social networking website, a blogging website, a microblogging website, a podcasting website, a web feed server (a RSS server), a forum website, an information aggregator website, a social bookmarking website, a media platform, a game platform, a content sharing platform, and so forth. According to various embodiments, the client devices 102 may interact with the social media websites 106 by communicating transmissions via the network 112.

The e-mail server 108 may transfer e-mail messages from one computer to another computer, using client-server application architecture. The e-mail server 108 may be used by one client device 102 to send a message to another client device 102, may be used by the reward management system 104 to send messages to the client devices 102.

The financial institution server 110 may include a banking server, a clearing server, a credit/debit/prepaid card server, a virtual account server, an on-line banking server, and so forth. In this disclosure, the term “financial institution” means any organization in the business of transacting money and providing financial services. Financial institutions, such as commercial banks, may provide services like establishing banking accounts, cash withdrawals and deposits, issuing credit cards and debit cards, and so forth. The financial institution server 110 may be associated with user payment cards (such as credit, debit or prepaid cards), and may be used to make payments by cardholders and/or receive payments from any organizations or individuals.

The implementation described below may include client-server and/or cloud computing environments. The Internet is one example of such environments. However, any other appropriate type of environments, such as an intranet, wireless network, telephone network, peer-to-peer network, or so forth, may be used.

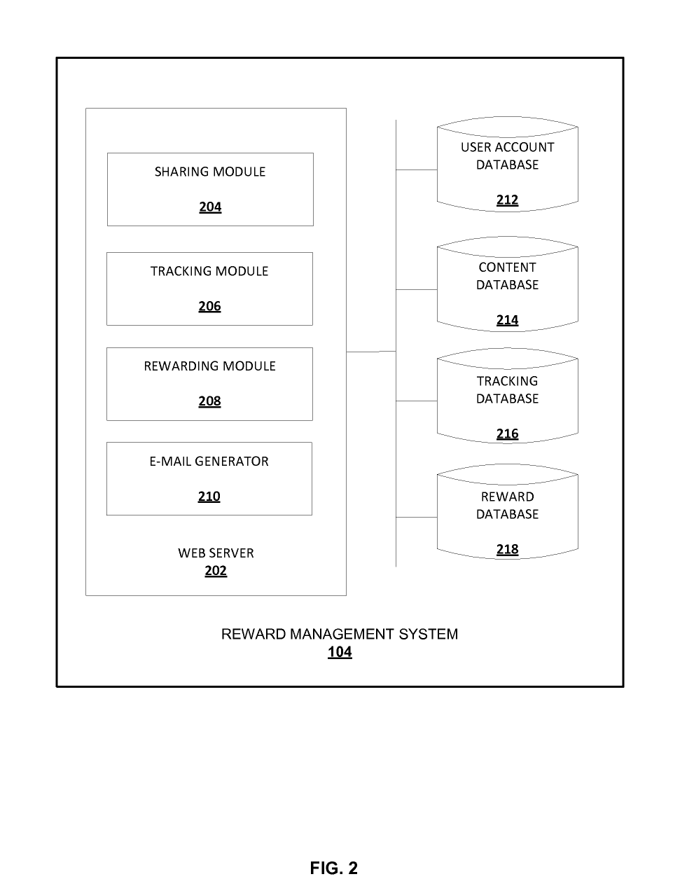

FIG. 2 is a diagram of an exemplary reward management system 104, according to an exemplary embodiment. In this embodiment, the reward management system 104 includes a web server 202, a sharing module 204, a tracking module 206, a rewarding module 208, an e-mail generator 210, a user account database 212, a content database 214, a tracking database 216, and a reward database 218. In other embodiments, the reward management system 104 may include additional, fewer, or different modules for various applications.

Web server 202 and databases 212-218 of reward management system 104 may communicate with one or more client devices 102, one or more web services providing social media websites 106, e-mail server 108, and one or more financial institutions 110 via the network 112. The connection may be provided via an Application Programming Interface (API) interface, for example.

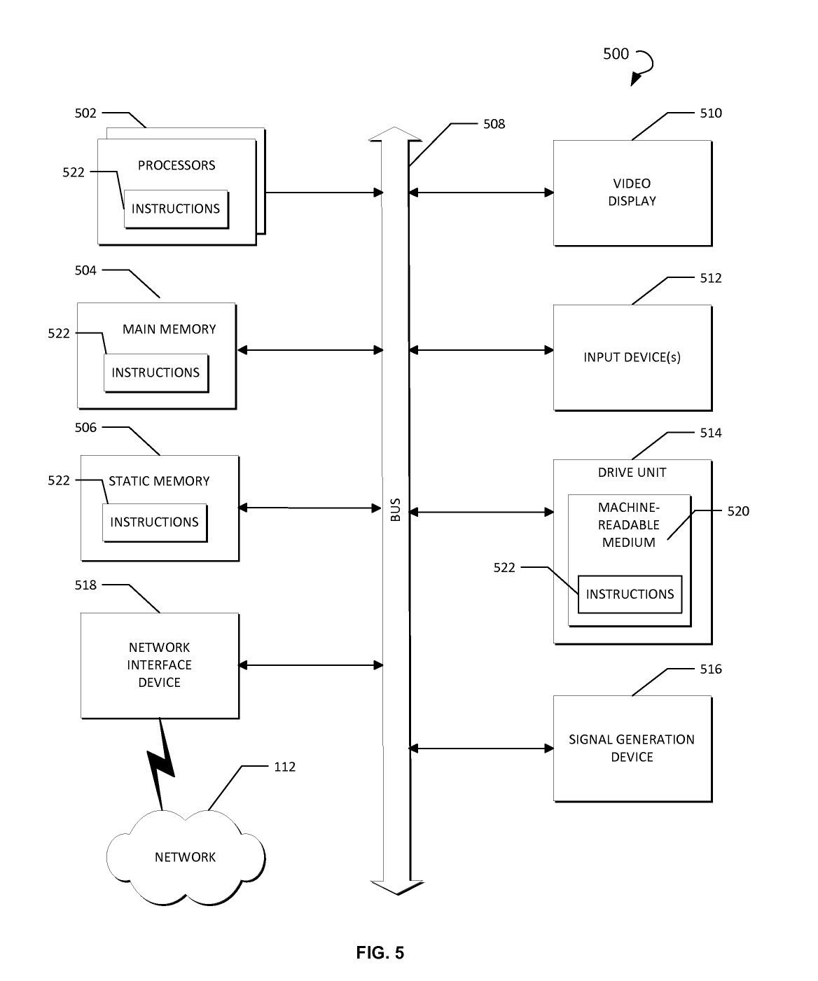

The web server 202 can be implemented as hardware (for example, as discussed with reference to the system of FIG. 5) having software installed thereon that implement one or more of modules 204-210, as well as functionality necessary to receive and manage sharing user requests, transmitting content, and rewarding the users, according to various embodiments disclosed herein. The web server 202 may optionally host a web service, for example a service that provides a website, configured to manage users in sharing rewards, manage user accounts, track user actions, manage sharing and rewarding functionality, provide information related to rewarding methods, and so forth.

Pursuant to the exemplary embodiment, sharing module 204 may allow the sharing of digital content via one or more destinations, such as social networking websites 106, the e-mail server 108, or the user account database 212. The term “digital content,” or “content,” as used herein, may include but is not limited to text, audio, video, images, and other multimedia. The digital content may also include hyperlinks to external websites. The digital content may also include user information, such as a name, a nickname, user credentials, a representative picture/photo, address, phone number, fax number, e-mail address, snail mail address, age, gender, occupation, financial institution account details, game character information, or other form of contact and personal information.

The sharing module 204 is configured to receive a user request to share digital content; retrieve the content to be shared from the client device 102, an external website or the content database 214; and transmit the content to be shared to one or more destinations (including the social media website 106 or the user account database 212). Accordingly, in one embodiment, if the content to be shared relates to personal information, it is retrieved from the client device 102, and then is transmitted and stored in the user account database 212.

In another embodiment, when the content to be shared relates to a social media post, a blog post, or a website content reviewed by the user on a social media website 106, the content may be retrieved from said social media website 106 and transmitted for sharing to one or more destinations (such as the same or another social web site 106). In still another embodiment, the retrieved content to be shared may be transmitted by e-mail to one or more connections (i.e., users of network services with a relationship with user through the service) of the user. In yet another embodiment, when the content to be shared relates to software (such as a game) executed on a client device 102, the content may be retrieved from the content database 214 and then transmitted to one or more destinations, such as the social media website 106. Those who are skilled in the art would understand that various sharing options can be applied.

The sharing module 204 may also be configured to generate, format, or filter digital content to be shared based on information retrieved from the content database 214 or external social media website 106. For example, if the user wins a stage in a game run on the client device 102, this information (e.g., user score) can be shared by the user. Accordingly, the user score can be retrieved by the sharing module 204, merged with the template content retrieved from the content database 214, and then shared via one or more external social media websites 106. According to another example, digital content can be formatted in the terms of video and audio coding/decoding. Those skilled in the art would understand that content generation and formatting relates to any suitable conversion.

The tracking module 206 is configured to track whether digital content is duly delivered to one or more selected destinations. Specifically, the tracking module 206 tracks the content transmitted by the sharing module 204 to one or more external social media websites 106, the user account database 212, or the e-mail server 108. The tracking module 206 is configured to receive and analyze confirmation messages of one or more destinations, such as the external social media website 106, the user account database 212, and the e-mail server 108. The confirmation message either confirms that the content has been successfully shared (e.g., posted as a blog entry or a social network entry, sent by e-mail, or stored in the database), or, alternatively, the content has not been shared due to errors or other system reasons.

The rewarding module 208 is configured to provide a reward to the user who shared information via the reward management system 104, according to one or more rewarding methods. According to various embodiments disclosed herein, a reward refers to any monetary and non-monetary incentives, and includes one or more of the following: money, virtual money, reward points, a financial discount percentage, a rebate amount, a free service, a free product, a cash back rebate, and so forth. Rewarding methods may be associated with one or more of the following: a type and amount of shared content, a number of destinations that content is shared to, traffic generated due to shared content, a number of visitors to the external website associated with the shared content, and a number of purchases associated with the shared content.

The rewarding module 208 is configured to calculate a reward based on a corresponding rewarding method and provide a reward to the user via one or more of the following destinations. If the reward is monetary, the rewarding module 208 requests one or more financial institution servers 110 to credit corresponding accounts of the users with the amount stipulated by the rewarding method. Alternatively, if the reward is non-monetary, the rewarding module 208 requests one or more external websites or the website hosted by the web server 202 to credit a user account with virtual money, reward points, provide a free product or service, and so forth.

The e-mail generator 210 is configured to drive messaging functionality to receive, transmit, and route messages, such as e-mails or instant messages, to the social media websites 106, the e-mail server 108, or the client devices 102.

The user account database 212 stores user related information, such as user accounts (names, logins, passwords, etc.) at different social media websites. The content database 214 stores different digital content templates that can be retrieved for sharing. Such templates can be selected based on user preferences, user account, user actions, and so forth. The tracking database 216 stores log files for tracking the shared content. The reward database 218 stores reward related data, such as rewarding methods, rewards associated with users, and the like.

The users may register and establish personal accounts (profiles) on the website hosted by the web server 202. Personal accounts may include information, such as a name, an address, contact information, earned reward points, and so forth. Companies that are interested in rewarding customers via the “Share with Reward” model, according to various embodiments disclosed herein, may also register with the website hosted by the web server 202. Company profiles may include information, such as a name of business, a type of business, an address, contact information, rewarding methods, and so forth. The users may access the database 212 via the web server 202 to review, modify or delete information stored therein.

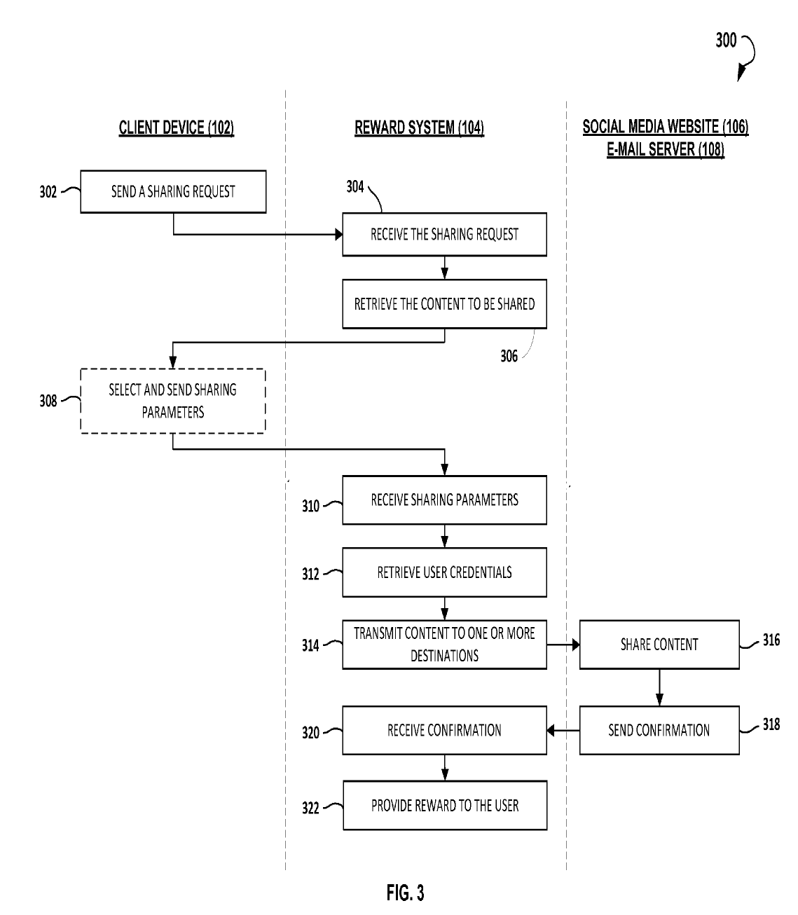

FIG. 3 illustrates an exemplary method 300 for sharing digital content and rewarding a user for sharing digital content, according to an exemplary embodiment. At step 302, a user at a client device sends a sharing request via the client device 102. Specifically, the request may involve the user providing input to share content while viewing a website, such as social media website 106 (e.g., a social networking website) on web browser 114 at the client device 102. Alternatively, the software 116 running on the client device 102 may include a selection feature for the user to share digital content. The user may provide input to indicate that the user desires to share digital content through a network service via the user's contacts, such as members of the social networking website 106. The selection may cause a code (such as JavaScript, HTML, PHP, etc.) to be executed in the client device 102, driving the client device 102 to send the sharing request to the reward management system 104 via the network 112.

After the sharing request is sent, it is received in step 304 by the sharing module 204 of the reward management system 104. The sharing module 204 may identify possible pieces of digital content to be shared. In one example, the sharing request may include at least a part of the content to be shared. Alternatively, the sharing request may include a hyperlink to the content to be shared. In yet another example, the sharing request includes a destination or identifier of the content to be shared.

In step 306, sharing module 204 retrieves content to be shared from the sharing request, the content database 214, an external online source (e.g. a social media website 106), or a combination thereof. In one example, the sharing request may include an indication that the user utilizes specific software, and thus the sharing module 204 may retrieve a template message (the content to be shared) from the content database 214 for further spreading via the user connections. In yet another example, the sharing request may include an obtained score value of a game installed in the client device 102, which score the user desires to share. In this case, the sharing module 204 retrieves a template message from the content database 214 and merges the score and the template message. In yet another example, the sharing request may include a hyperlink to the content to be shared. In this case, the sharing module 204 retrieves the content to be shared from the external web server or website, such as the social media website 106 or the like. Those skilled in the art would understand that sharing requests may be implemented in different ways.

Shared content may be formatted by the reward management system 104 to suit requirements of the destination for sharing the content. For example, media data, such as video or audio data, can be formatted. In addition, the content to be shared may optionally be filtered by the reward management system 104 based on the content. For example, the filtering may be useful in removing authorized content (e.g., copyrighted material, or images of unsupported format, etc.) from spreading to different destinations.

Returning to FIG. 3, in response to receiving the sharing request, the user may then be optionally provided with the ability to select sharing parameters. In step 308, the user may select and sharing parameters and the sharing parameters are transmitted to the reward management system. The sharing parameters may include an indication of which of the identified pieces of content the user desires to share, options for formatting the selected pieces of content for sharing, and where to send the formatted content within the social media websites. Different embodiments may allow the user to select one or more of these types of parameters. For example, the user can specify that the content can be e-mailed to one or more members, posted to the user's blogging website, or added to the user's profile page on a social networking website. The sharing parameters may also include the user's credentials (e.g., a login and a password for the social media website). These user credentials can be used to ensure that the content is posted only to areas where the member has permission to post. In some embodiments, one or more sharing parameters are selected automatically by the reward management system in response to the user's selection of the content to be shared.

In step 310, the sharing parameters are received by the reward management system 104. Further content processing is performed based on the sharing parameters. The method 300 further proceeds to the step 312, when the reward module 104 retrieves the user credentials (if they were not received in the previous step 310). The user credentials, such as a login and password for accessing one or more destinations (i.e. an e-mail server, a social media website, e.g., a social networking website) can be retrieved from the user account database 212, web cookies stored in the client device 102, the browser 114 or the software 116 embedded in the client device 102, or requested from the user. Different embodiments may be applied to retrieve the credentials of the user.

In the next step 314, the content to be shared (in one example, already formatted or filtered) is transmitted to one or more destinations within the system environment 100. Specifically, the content can be transmitted to the social media website 106, such as a social networking website, a blogging website, a microblogging website, a RSS server, an e-mail server 108, and so forth. As mentioned above, the user can make selections for sending the shared content to various destinations within one or more external websites. For example, the user can share the content with specific members of the social networking website, or spread the shared content by e-mail to selected contacts of the user. In this step, the content to be shared may be provided with the user credentials or other parameters. In addition to transmitting the content (step 314) to the destinations, the tracking module 206 can also create a log file and store it in the tracking database 216. The log file indicates that the content has been shared by the user. The file may include a timestamp, the content, a hyperlink to the content, the content description, tags, destinations, and the like.

In step 316, the social media website 106 or the e-mail server 108 authenticates the user and shares the provided content in line with the sharing parameters. If the content was shared successfully, the social media website 106 or the e-mail server 108 may return a confirmation message in step 318. In the next step 320, the tracking module 206 receives the confirmation message and accordingly updates the log file in the tracking database 216. The tracking module 206 may keep tracking destinations (e.g., social networking websites, e-mails, etc.) associated with the shared content. The tracking module 206 may maintain the tracking database 216 for this purpose. For example, the tracking module 206 may further track traffic generated due to shared content, a number of visitors to a social media website associated with the shared content, a number of purchases associated with the shared content, a number of re-sharing, a number of external links to the shared content, popularity (ranking, ratings, etc.), and so forth. In one embodiment, the tracking module 206 may periodically check the external website 106 of the shared content to determine if the original copy of the content has been deleted or modified.

In step 322, the rewarding module 208 may provide a reward to the user who shared the content. The rewarding module 208 calculates the reward based on a rewarding method and provides the reward to the user via one or more destinations. Rewarding methods may involve conditions to be satisfied before the user gets a reward. If the reward is monetary, the rewarding module 208 may request one or more financial institution servers 110 to credit corresponding accounts of the user who shared. Alternatively, if the reward is non-monetary, the rewarding module 208 may request one or more external websites 106 or the website hosted by the web server 202 to credit the user account with virtual money, reward points, provide a free product (including a downloadable product or part of a product), free service, and so forth.

Sharing of content to obtain a reward may be performed in different ways. For example, a user of an application may share content such as an achievement in a game, the act of participating in a game or program, or other solo activity. A user may also share content as part of a group of users in the program or game sharing a particular portion of content, sharing at a particular time, or otherwise sharing content with a common aspect. In some embodiments, a game may provide players with notifications of available rewards if they share a particular content at a particular time, a group of players share content at a particular time, or other conditions are met. Other actions that may trigger granting a reward may include re-broadcasting content shared by another user of a social network (e.g., re-tweeting), providing a pyramid scheme game that rewards users for sharing, providing group sharing based on desirable metrics, geo-based rewards, and other actions.

The reward provided to the user may be based at least on part on how the content or information is shared. For example, a user reward may have a quantity or value that is proportional to the number of contacts the content is shared with, such as a first reward for sharing with one user and a second reward if shared with five users. A reward may also be based on an action of a contact that receives the shared content, such as an action of signing up for the service from which the reward was provided. The rewards may be available to the user and others through a normal application experience or only as a result of sharing information (the latter serving as an extra incentive to encourage users to share the information).

Upon sharing the content, the user may be optionally notified of the award by e-mail. For this purpose, the e-mail generator 210 may generate and send a corresponding e-mail to the user indicating that the content has been successfully shared, (or not shared, based on specific reasons), and that the user is provided with the reward (or not shared, based on different reasons). Alternatively, the user may be notified within the application that provides the reward, for example while playing a game, visiting an online store, or performing another activity.

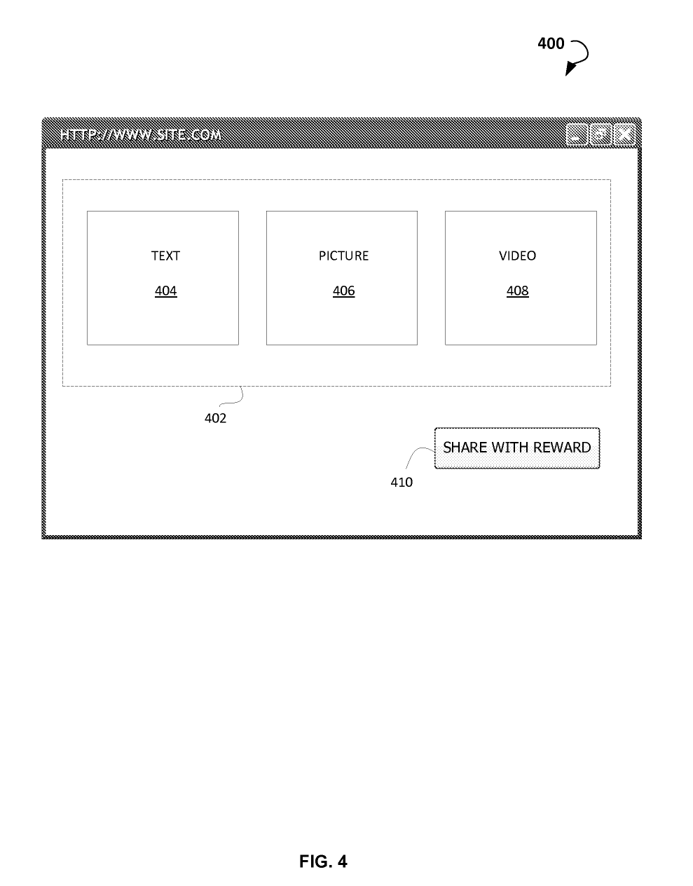

FIG. 4 is a web page 400 of an exemplary external social media website 106 displayed in the web browser 114 of the client device 102, according to an exemplary embodiment. The web page 400 is one example of a graphical user interface that allows the user to send the sharing request.

The web page 400 includes various types of content 402, such as a block of text 404, a picture 406, and a video 408. The illustrated web page 400 is merely an one of many examples of a web page containing content 402 that can be shared. Generally, the web page 400 may include multiple content types in various configurations and layouts. The user may desire to share some or all of the web page content via one or more destinations, such as the social media websites 106. In order to share the content, the web page 400 is further provided with a user interface control means 410. The control means 410, when selected by the user, causes a sharing request to be sent to the reward management system 104, as described with reference to FIG. 3. The control means 410 can be implemented as one or more buttons, icons, selectable links, or various other selectable objects. The control means 410 may be associated with a code provided in the web page 400, such as HTML, JavaScript, PHP, and the like, that can be executed in the web browser 114 and causes the sharing request to be sent to the reward management system 104. The control means 410 may also be associated with digital content that is available for sharing. For example, the control means 410 may be associated with content accessible via a specific Uniform Resource Locator (URL). Those skilled in the art would understand that reward sharing control can also be embedded in the software run on the client device 102.

FIG. 5 shows a diagrammatic representation of a computing device for a machine in the example electronic form of a computer system 500, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor or multiple processors 502 (e.g., a central processing unit (CPU), a graphics processing unit (GPU), or both), and a main memory 504 and a static memory 506, which communicate with each other via a bus 508. The computer system 500 can further include a video display unit 510 (e.g., a liquid crystal displays (LCD) or a cathode ray tube (CRT)). The computer system 500 also includes at least one input device 512, such as an alphanumeric input device (e.g., a keyboard), a cursor control device (e.g., a mouse), a microphone, and so forth. The computer system 500 also includes a disk drive unit 514, a signal generation device 516 (e.g., a speaker), and a network interface device 518.

The disk drive unit 514 includes a machine-readable medium 520, which stores one or more sets of instructions and data structures (e.g., instructions 522) embodying or utilized by any one or more of the methodologies or functions described herein. The instructions 522 can also reside, completely or at least partially, within the main memory 504 and/or within the processors 502 during execution thereof by the computer system 500. The main memory 504 and the processors 502 also constitute machine-readable media.

The instructions 522 can further be transmitted or received over the network 112 via the network interface device 518 utilizing any one of a number of well-known transfer protocols (e.g., Hyper Text Transfer Protocol (HTTP), CAN, Serial, and Modbus).

While the computer-readable medium 520 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, HTML, Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

The embodiments described herein can be implemented by various means, depending upon the application. For example, embodiments can be implemented in hardware, firmware, software, or a combination thereof. For a hardware implementation, embodiments can be implemented with processors, controllers, micro-controllers, microprocessors, electronic devices, other electronic units designed to perform the functions described herein, or a combination thereof. Memory can be implemented within a processor or external to the processor. As used herein, the term “memory” refers to any type of long term, short term, volatile, nonvolatile, or other storage device and is not to be limited to any particular type of memory or number of memories, or type of media upon which memory is stored. For a firmware and/or software implementation, embodiments can be implemented with modules such as procedures, functions, and so on, that perform the functions described herein. Any machine-readable medium tangibly embodying instructions can be used in implementing the embodiments described herein.

Thus, the method for sharing and rewarding has been described. The “Share with Reward” method gives users immediate rewards (virtual or real) for sharing specified marketing messages within social media websites and e-mail contacts, or providing the company with confirmed personal contact information. This enables companies to entice visitors/users/gamers to share key marketing messages within the website/game/application experience.

To the accomplishment of the present technology, the one or more aspects include the features hereinafter fully described and particularly pointed out in the claims. The description and the drawings set forth in detail certain illustrative features of the one or more aspects. These features are indicative, however, of but a few of the various ways in which the principles of various aspects may be employed, and this description is intended to include all such aspects and their equivalents.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

1. A computer-implemented method of rewarding a user for sharing digital content, the method comprising:
receiving, from a user, a request to share the digital content, the received request including an identification of the digital content to be shared;
retrieving the identified digital content;
transmitting the retrieved digital content to one or more destinations for sharing; and
providing a reward to the user for the request to share the digital content.

2. The computer-implemented method of claim 1, wherein the one or more destinations comprise a social networking website, a blog, a microblog, a website, an e-mail server, a web server, and a database.

3. The computer-implemented method of claim 2, further comprising retrieving user credentials, the user credentials being used for accessing one or more destinations.

4. The computer-implemented method of claim 1, further comprising receiving a confirmation message in response to a successful delivery of the digital content to a destination.

5. The computer-implemented method of claim 4, wherein the providing the reward to the user is based on the confirmation message.

6. The computer-implemented method of claim 1, wherein an amount of the reward is based on one or more of the following: a shared content type, a number of destinations, traffic generated due to the digital content sharing, and a number of visitors to a website associated with the shared digital content.

7. The computer-implemented method of claim 1, further comprising receiving sharing parameters from the user.

8. The computer-implemented method of claim 7, wherein the transmission of the digital content to one or more destinations is based at least in part on the sharing parameters.

9. The computer-implemented method of claim 7, wherein the sharing parameters indicate one or more of the following: which digital content the user wishes to share, how the digital content is to be formatted, and at which destinations the user wishes the digital content to be shared.

10. The computer-implemented method of claim 1, wherein the sharing request is received responsive to the user selection of a website control or a software control, the website control comprising an object included within the website that executes a predetermined code when selected by the user, and the software control comprising an object in software that executes a predetermined code when selected by the user.

11. A system for rewarding a user for sharing digital content, the system comprising:
at least one subsystem configured to receive, from a user, a request for sharing digital content, the received request including an identification of the digital content to be shared;
at least one subsystem configured to retrieve the identified digital content to be shared, the digital content being associated with the user;
at least one subsystem configured to transmit the retrieved digital content to one or more destinations for sharing;
at least one subsystem configured to provide a reward to the user for the request to share the digital content; and
a memory coupled to the at least one subsystem, the memory comprising computer code for the at least one subsystems.

12. The apparatus of claim 11, wherein the one or more destinations comprises a social networking website, a blog, a microblog, a website, an e-mail server, a web server, and a database.

13. The apparatus of claim 12, wherein the at least one subsystem is further configured to retrieve user credentials, the user credentials being used for accessing one or more destinations.

14. The apparatus of claim 11, wherein the at least one subsystem is further configured to receive a confirmation message on a successful delivery of the digital content to the destination.

15. The computer-implemented method of claim 14, wherein the reward is provided to the user based on the confirmation message.

16. The computer-implemented method of claim 11, wherein an amount of the reward is associated with one or more of the following: a shared content type, a number of destinations, traffic generated due to sharing of the digital content, a number of visitors to a website associated with the shared digital content, and a number of sales associated with the shared digital content.

17. The computer-implemented method of claim 11, wherein the at least one subsystem is further configured to receive sharing parameters from the user.

18. The computer-implemented method of claim 17, wherein the transmission of the digital content to one or more destinations is based at least in part on the sharing parameters.

19. The computer-implemented method of claim 17, wherein the sharing parameters indicate one or more of the following: which digital content the user wishes to share, how the digital content is to be formatted, and at which destinations the user wishes the digital content to be shared.

20. A non-transitory computer-readable medium having instructions stored thereon, which when executed by one or more processors, cause the one or more processors to:
receive, from a user, a request to share digital content, the received request including an identification of the digital content to be shared;
retrieve the identified digital content to be shared, the digital content being associated with the user;
transmit the retrieved digital content to one or more destinations for sharing; and
provide a reward to the user for the request to share the digital content.
